(19) United States
(12) Patent Application Publication
(10) Pub. No.: US 2013/0008917 A1
(43) Pub. Date: Jan. 10, 2013

(54) INDOOR OPEN TYPE DOOR PANEL MOUNTING STRUCTURE

(76) Inventor: Ho-Kuei Huang, New Taipei City (TW)

(21) Appl. No.: 13/177,512

(22) Filed: Jul. 6, 2011

(51) Int. Cl. B65D 51/04; E05F 11/54; E06B 3/34

(52) U.S. Cl. 220/810; 49/358

(57) ABSTRACT

An indoor open type door panel mounting structure includes a construction having an access hole, a door panel hinged to the construction at the top side of the access hole and adapted for closing the access hole, and a driving mechanism formed of an actuator and pivotally connected between the construction adjacent to the access hole and an inner surface of the door panel and operable to bias the associating door panel outwardly toward the outside of the construction and inwardly toward the inside of the construction in opening/closing the associating access hole.

### BACKGROUND OF THE INVENTION

1. Field of the Invention

The present invention relates to door panel mounting structure and more particularly, to an indoor open type door panel mounting structure installed in a construction for moving an indoor open type door panel to close/open an access hole.

2. Description of the Related Art

The door panel of a construction, such as a container or drying oven, or the gate or garage of a house, may be made in a sliding or swinging manner. Either a sliding door panel or swinging door panel is used, much space around the access hole must be maintained for allowing movement of the door panel between the close position and the open position, limiting space utilization. Further, the mechanism for closing/opening the door panel is commonly arranged on the outside of the door panel and can easily be destroyed by an evil person.

### SUMMARY OF THE INVENTION

The present invention has been accomplished under the circumstances in view. It is the main object of the present invention to provide an indoor open type door panel mounting structure, which has the driving mechanism arranged at the inner side of the door panel for moving the door panel outwardly toward the outside of the construction and inwardly toward the inside of the construction in opening/closing the associating access hole, effectively prohibiting intrusion of evil persons.

It is another object of the present invention to provide an indoor open type door panel mounting structure, which is designed to bias the door panel upwardly outwards in opening the access hole so that the space around the access hole can be fully utilized.

It is still another object of the present invention to provide an indoor open type door panel mounting structure, which uses a link or two links to couple the door panel to the actuator of the driving mechanism for allowing adjustment of the arm of force to fit different application requirements.

To achieve these and other objects of the present invention, an indoor open type door panel mounting structure comprises a construction having at least one access hole defined in one of a plurality of wall panels thereof, at least one door panel respectively hinged to the construction and adapted for closing the at least one access hole, and at least one driving mechanism each comprising an actuator respectively pivotally connected to the construction around the at least one access hole and at least one link pivotally coupled between the actuator and the inner surface of each door panel and operable to bias the associating door panel outwardly toward the outside of the construction and inwardly toward the inside of the construction in opening/closing the associating access hole.

### BRIEF DESCRIPTION OF THE DRAWINGS

FIG. 1 is a sectional elevation of an indoor open type door panel mounting structure in accordance with a first embodiment of the present invention.

FIG. 2 is an exploded view of a part of the indoor open type door panel mounting structure in accordance with the first embodiment of the present invention.

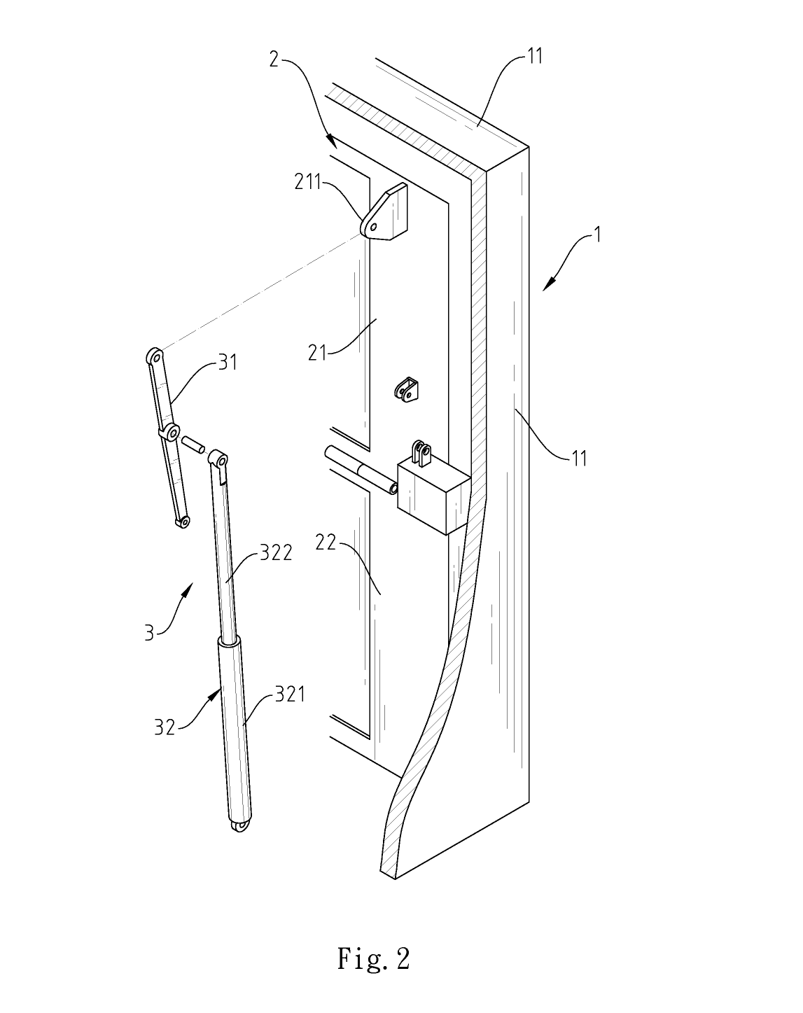

FIG. 3 is a schematic drawing of the first embodiment of the present invention, illustrating the indoor open type door panel mounting structure in operation (I).

FIG. 4 is a schematic drawing of the first embodiment of the present invention, illustrating the indoor open type door panel mounting structure in operation (I).

FIG. 5 is a sectional elevation of a part of an indoor open type door panel mounting structure in accordance with a second embodiment of the present invention.

FIG. 6 is a schematic structural view of an indoor open type door panel mounting structure in accordance with a third embodiment of the present invention.

FIG. 7 is a schematic structural view of an indoor open type door panel mounting structure in accordance with a fourth embodiment of the present invention.

FIG. 8 is a schematic structural view of an indoor open type door panel mounting structure in accordance with a fifth embodiment of the present invention.

FIG. 9 corresponds to FIG. 8, illustrating the driving mechanism operated and the door panel opened.

### DETAILED DESCRIPTION OF THE PREFERRED EMBODIMENT

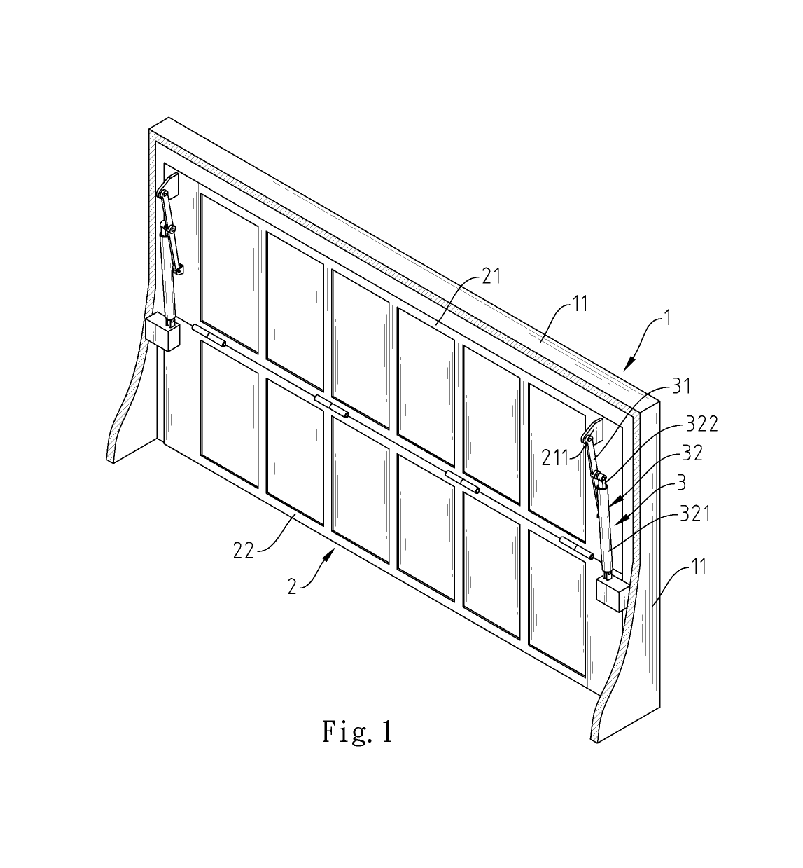

Referring to FIGS. 1˜3, an indoor open type door panel mounting structure in accordance with a first embodiment of the present invention is shown comprising a construction 1, a door panel 2 pivotally mounted in the construction 1, and two driving mechanisms 3 adapted for moving the door panel 2 between an open position and a close position.

The construction 1 can be a container, house or driving oven consisting of a plurality of wall panels 11. Further, at least one wall panel 11 defines an access hole 111.

The door panel 2 is pivotally connected to the construction 1 and adapted for closing the access hole 111. Further, the door panel 2 consists of a first panel member 21 and a second panel member 22. The first panel member 21 has its one side (the top side) hinged to one wall panel 11 of the construction 1 at the top side of the access hole 111. The second panel member 22 is hinged to the opposite lateral side of the first panel member 21. Further, the first panel member 21 has two lugs 211 bilaterally located on the back side adjacent to the top side of the access hole 111.

The driving mechanisms 3 are bilaterally coupled between the door panel 2 and the wall panel 11 of the construction 1 providing the access hole 111. Each driving mechanism 3 comprises an actuator 32 and a link 31. The actuator 32 can be an air cylinder or hydraulic cylinder. The link 31 has its one end pivotally coupled to one lug 211 of the first panel member 21 of the door panel 2, and its other end pivotally connected to the inner surface of the first panel member 21. The actuator 32 comprises a casing 321, which has its one end pivotally connected to the inner surface of the wall panel 11 of the construction 1 that defines the access hole 111, and a reciprocating rod 322, which has its one end coupled to and movable in and out of the other end of the casing 321 and its other end pivotally connected to the middle part of the link 31.

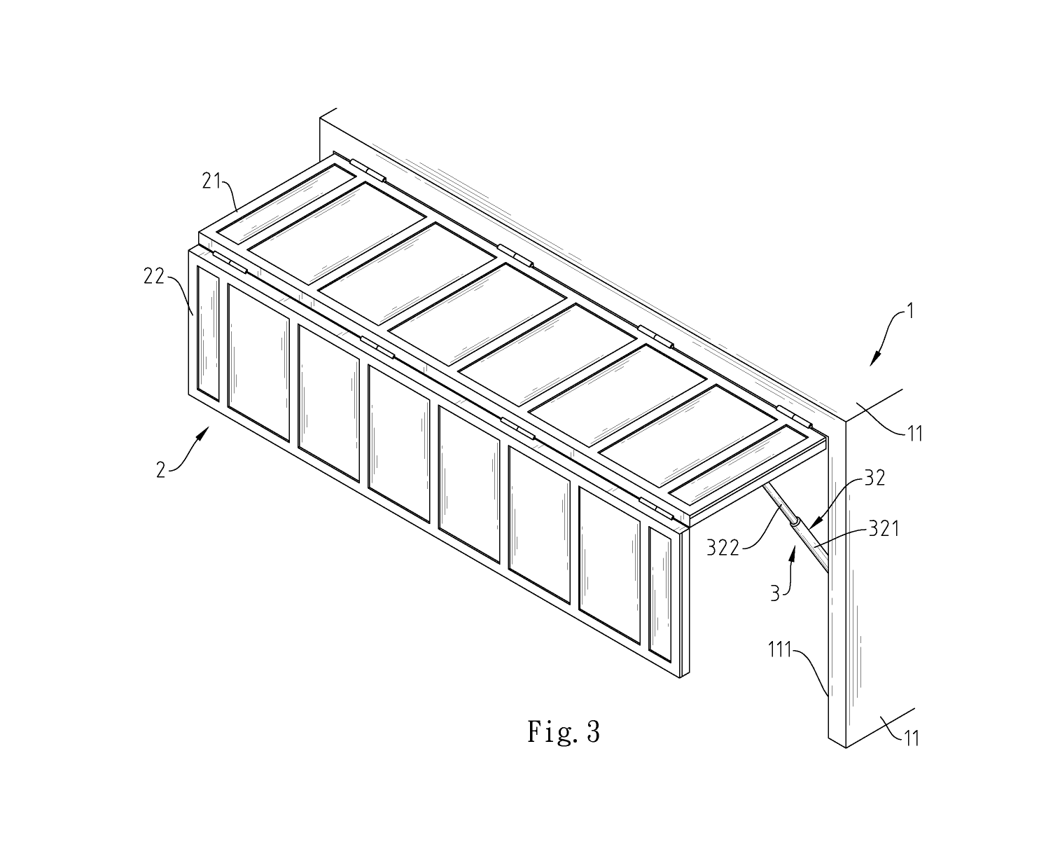

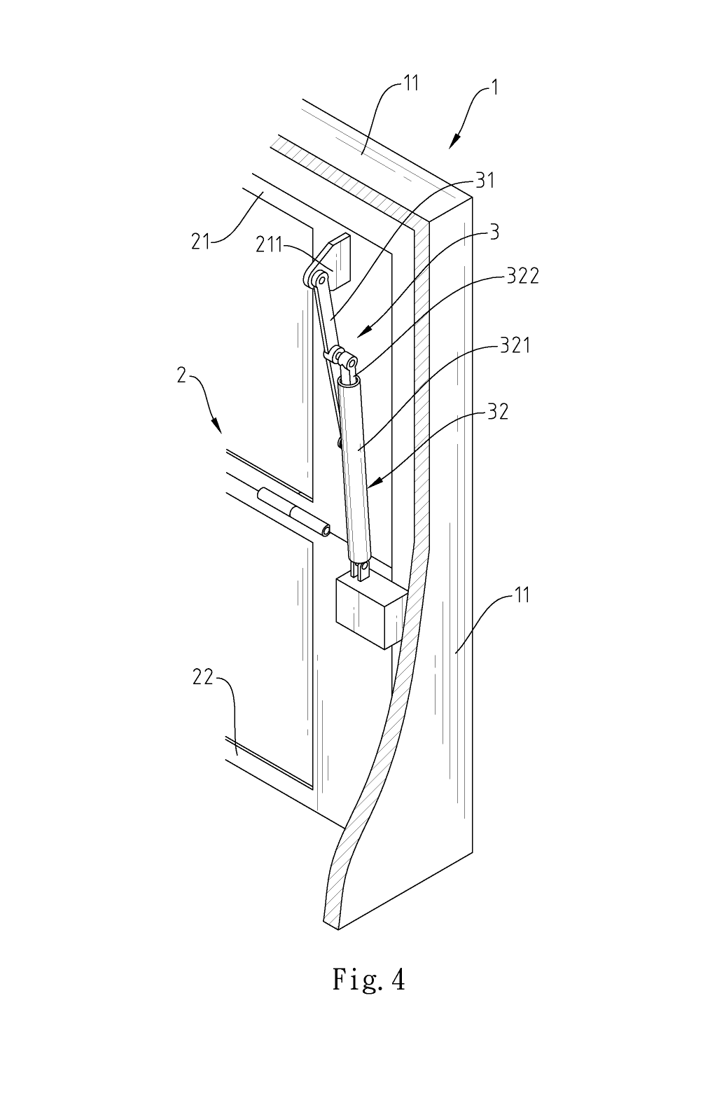

Referring to FIG. 4 and FIG. 3 again, when going to open the door panel 2 from the access hole 111, control the actuators 32 of the driving mechanisms 3 to extend the respective reciprocating rods 322 out of the respective casings 321 and to impart a biasing force to the respective links 31 and the lugs 211 in one direction, and therefore the first panel member 21 of the door panel 2 is turned outwardly and upwardly away from the access hole 111. When the first panel member 21 of the door panel 2 is opened the access hole 111, the second panel member 22 is carried away from the access hole 111 by the first panel member 21 and then automatically turned inwards and closely received to the first panel member 21 due to the effects of gravity and the functioning of the hinged structure between the first panel member 21 and the second panel member 22. When going to close the access hole 111, control the actuators 32 of the driving mechanisms 3 to move the respective reciprocating rods 322 back into the respective casings 321 respectively and to simultaneously impart a biasing force to the respective links 31 and the lugs 211 in the reversed direction, and therefore the first panel member 21 of the door panel 2 is turned inwardly downwards to the access hole 111. When the first panel member 21 of the door panel 2 is closed on the upper part of the access hole 111, the second panel member 22 is carried toward the access hole 111 by the first panel member 21 and lowered to close the lower part of the access hole 111. According to this design, each link 31 has is two opposite ends respectively pivotally connected to one lug 211 of the first panel member 21 and a part of the inner surface of the first panel member 21, and the has two bilaterally located on the back side adjacent to the top side of the access hole 111, and the reciprocating rod 322 of the actuator 32 of each driving mechanism 3 is pivotally connected to the middle part of the associating link 31, thus, the driving mechanisms 3 can turn the door panel 2 between the close position and the open position efficiently.

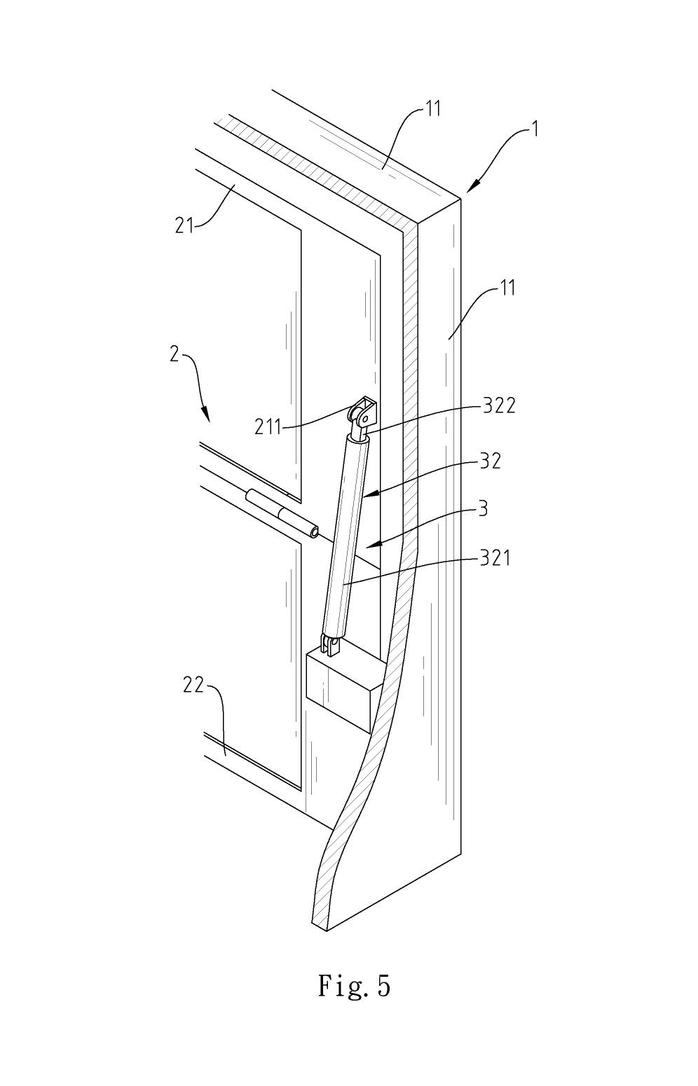

FIG. 5 is a sectional elevation of a part of an indoor open type door panel mounting structure in accordance with a second embodiment of the present invention. This second embodiment is substantially similar to the aforesaid first embodiment with the exception that each driving mechanism 3 eliminates the aforesaid link 31, and the reciprocating rod 322 of the actuator 32 of each driving mechanism 3 is directly and pivotally connected to one lug 211 of the first panel member 21 of the door panel 2. The operation of this second embodiment is same as the aforesaid first embodiment.

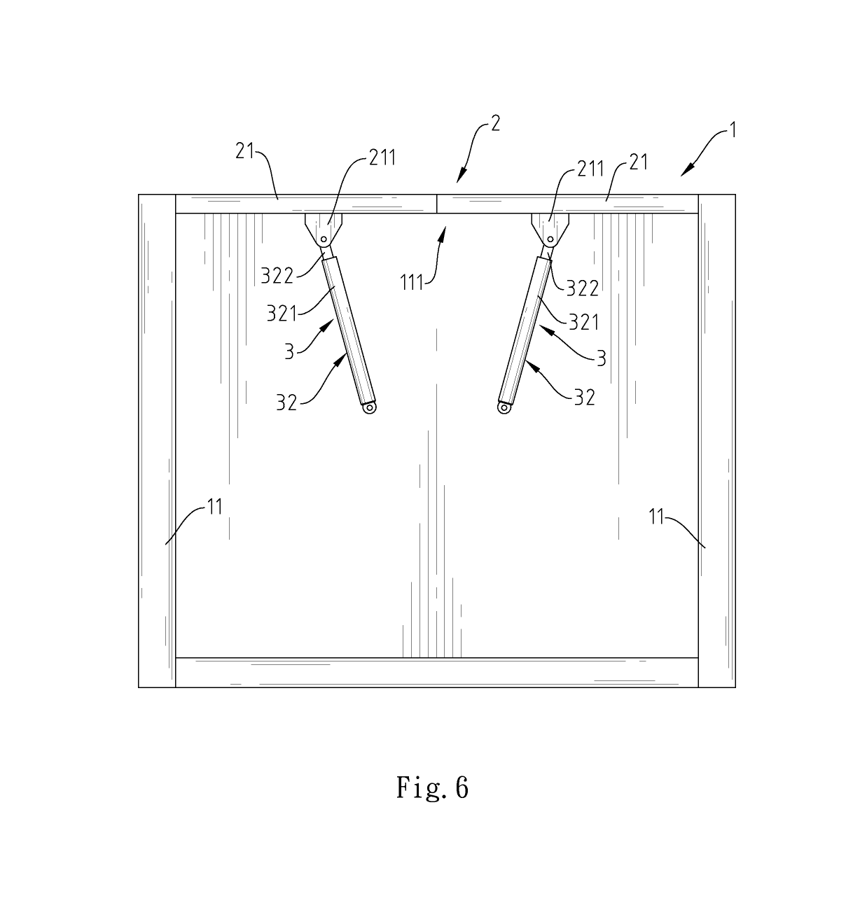

FIG. 6 illustrates an indoor open type door panel mounting structure in accordance with a third embodiment of the present invention. This third embodiment is substantially similar to the aforesaid second embodiment with the exception that the door panel 2 consists of two first panel members 21 arranged in parallel and respectively hinged to the wall panel 11 defines the access hole 111, and the two driving mechanisms 3 are respectively coupled between the first panel members 21 of the door panel 2 and the wall panel 11 of the construction 1 that defines the access hole 111.

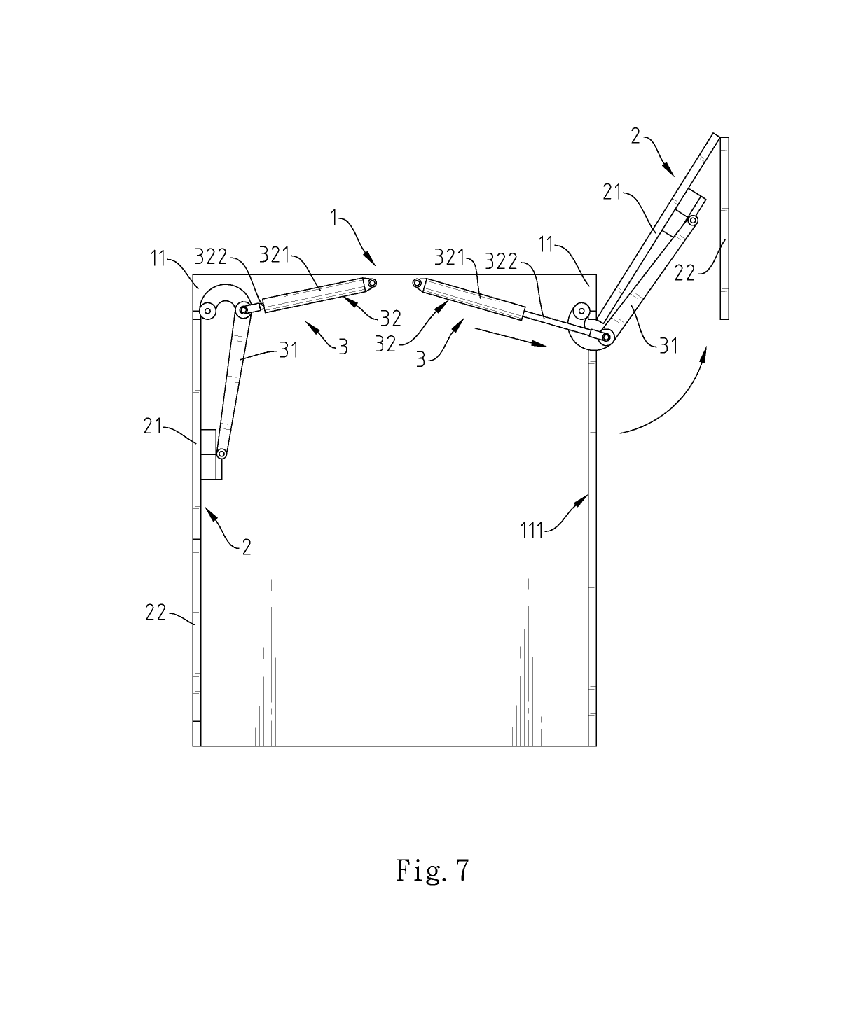

FIG. 7 illustrates an indoor open type door panel mounting structure in accordance with a fourth embodiment of the present invention. This fourth embodiment is substantially similar to the aforesaid first embodiment with the exception that each link 31 has its one end pivotally connected to the wall panel 11 at one side of the access hole 111 and its other end pivotally connected to the first panel member 21 of the door panel 2; the reciprocating rod 322 of the actuator 32 of each driving mechanism 3 is pivotally connected to the middle part of the associating link 31; the part of the link 31 of the actuator 32 of each driving mechanism 3 between the wall panel 11 and the associating reciprocating rod 322 is smoothly arched. Thus, when the reciprocating rod 322 of the actuator 32 of each driving mechanism 3 is extended out, the associating link 31 is forced to bias the linked first door panel 21 upwards, causing the first door panel 21 to carry the hinged second door panel 22 away from the access hole 111.

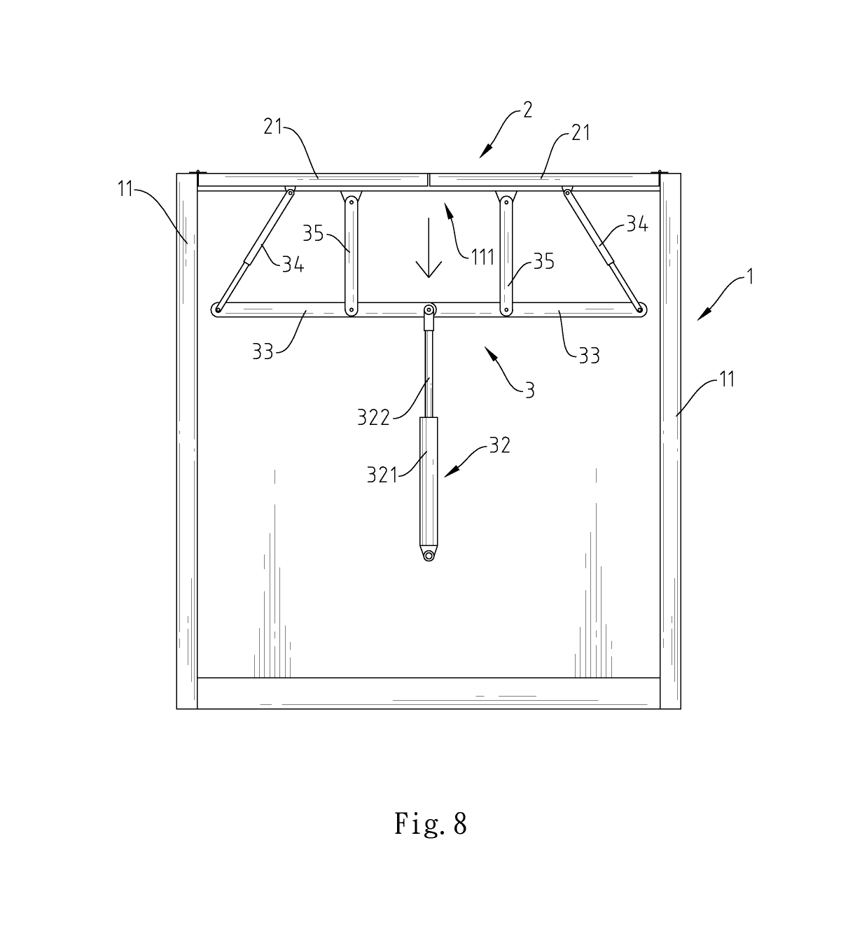

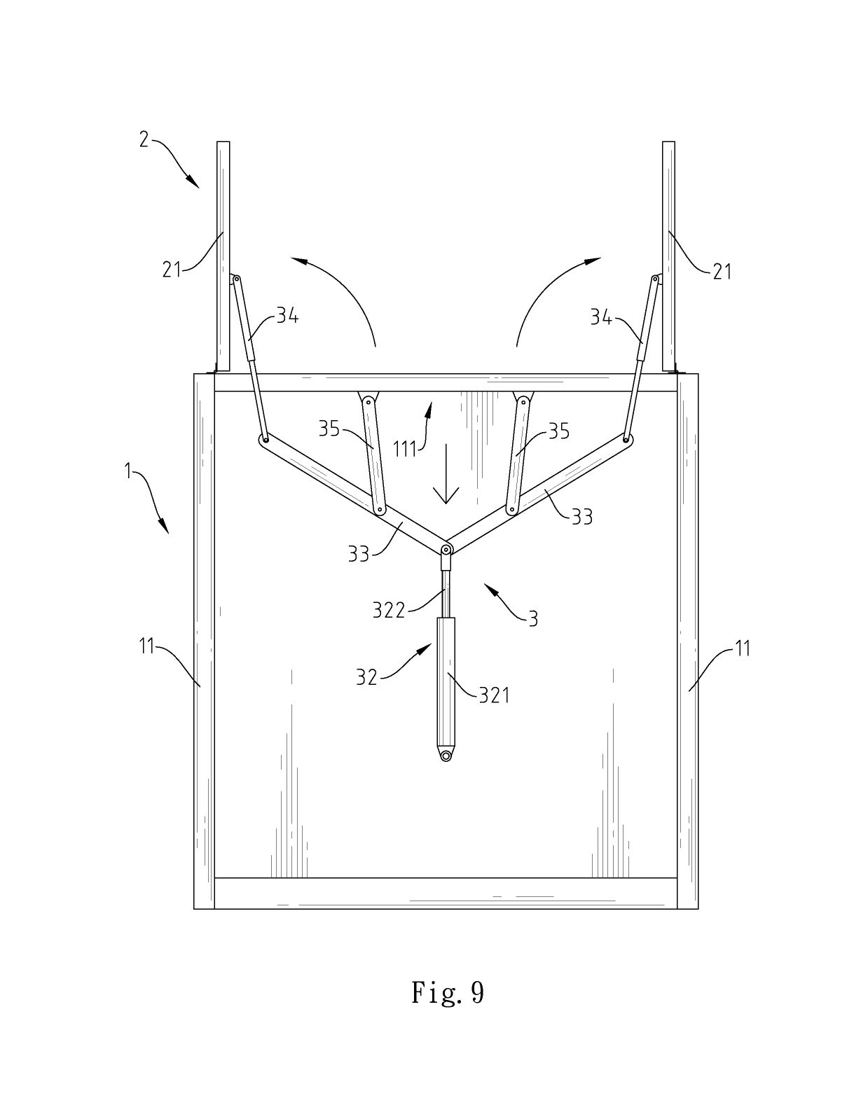

FIGS. 8 and 9 illustrate an indoor open type door panel mounting structure in accordance with a fifth embodiment. According to this fifth embodiment, the indoor open type door panel mounting structure comprises a construction 1, a door panel pivotally mounted in the construction 1, and a driving mechanism 3 adapted for moving the door panel 2 between an open position and a close position. The construction 1 has an access hole 111 defined in one wall panel 11 thereof. The door panel 2 consists of 2 first panel members 21 arranged in a parallel manner each having an inner lateral side disposed adjacent to each other and an outer lateral side hinged to the wall panel 11 at one of two opposite lateral sides of the access hole 111. The driving mechanism 3 comprises an actuator 32, which comprises a casing 321 connected to the wall panel 11 and a reciprocating rod 322 movable in and out of the other end of the casing 321, two links 33 each having one end thereof respectively pivotally coupled to the free end of the reciprocating rod 322, two push rods 34 respectively pivotally coupled between the other ends of the links 33 and the respective inner surfaces of the first panel members 21, and two connection rods 35 respectively pivotally coupled between the wall panel 11 and the links 33. When extending out the reciprocating rod 322 of the actuator 32, the links 31 are forced by the reciprocating rod 322 subject to the support of the connection rods 35 to bias the push rods 34 in one direction, thereby moving the first panel members 21 away from the access hole 111. On the contrary, when the reciprocating rod 322 is received back into the inside of the casing 321, the links 31 are forced by the reciprocating rod 322 subject to the support of the connection rods 35 to bias the push rods 34 in the reversed direction, thereby moving the first panel members 21 toward the access hole 111 from the open position to the close position.

Further, the construction 1 can be made having multiple access holes 111 and equipped with multiple door panels 2 and driving mechanisms 3 that are operable to move the respectively door panels 2 in closing/opening the respective access holes 111.

In conclusion, the invention provides an indoor open type door panel mounting structure, which has the advantages and features as follows:

1. The invention has the driving mechanism(s) 3 be arranged at the inner side of the door panel 2 so that an evil person cannot detach the driving mechanism(s) 3 to open the door panel 2 from the outside. The driving mechanism(s) 3 can be designed controllable by a remote controller or through the Internet. This remove control method can be achieved by commercial techniques.

2. Subject to coupling between the reciprocating rod 322 of the actuator 32 and the link(s) 33 to adjust the arm of force, the actuator 32 is selectively workable with door panels 2 having different weights.

3. The door panel 2 is configured to be biased upwardly to open the access hole 111, no extra space around the two opposite lateral sides or the front or rear side of the access hole 111 is necessary, and therefore the space around the access hole 111 can be fully utilized.

What the invention claimed is:

1. An indoor open type door panel mounting structure, comprising:
a construction having at least one access hole defined in one of a plurality of wall panels thereof;
at least one door panel respectively hinged to said construction and adapted for closing said at least one access hole; and
at least one driving mechanism each comprising an actuator respectively pivotally connected between said construction around said at least one access hole and an inner surface of each said door panel and operable to bias the associating door panel outwardly toward the outside of said construction and inwardly toward the inside of said construction in opening/closing the associating access hole.

2. The indoor open type door panel mounting structure as claimed in claim 1, wherein said construction is a container, house or drying oven.

3. The indoor open type door panel mounting structure as claimed in claim 1, wherein each said door panel comprises a first panel member hinged to one wall panel of said construction adjacent to one said access hole, and a second panel member hinged to one side of said first panel member remote from the wall panel of said construction.

4. The indoor open type door panel mounting structure as claimed in claim 1, wherein the actuator of each said driving mechanism is one of an air cylinder and a hydraulic cylinder.

5. The indoor open type door panel mounting structure as claimed in claim 1, wherein the actuator of each said driving mechanism comprises a casing having a fixed end pivotally connected to one wall panel of said construction adjacent to one said access hole and a free end opposite to said fixed end, and a reciprocating rod coupled to said casing and movable in and out of said free end of said casing, said reciprocating rod having one end thereof slidably coupled to said casing and an opposite end thereof pivotally connected to one wall panel of said construction adjacent to one said access hole.

6. The indoor open type door panel mounting structure as claimed in claim 5, said construction further comprises a plurality of lugs respectively mounted at an inner side of each wall panel thereof around each said access hole; each said driving mechanism further comprises a link, said link having one end thereof pivotally connected to one said lug, an opposite end thereof pivotally connected to one said door panel and a middle part thereof pivotally connected to the free end of the reciprocating rod of the actuator of the respective driving mechanism.

7. The indoor open type door panel mounting structure as claimed in claim 1, wherein each said door panel comprises two panel members respectively hinged to one wall panel of said construction at one side of one said access hole in a parallel manner.

8. The indoor open type door panel mounting structure as claimed in claim 1, wherein each said driving mechanism further comprises a link, said link having a first end pivotally connected to one wall panel of said construction at one side of one said access hole, a second end pivotally connected to one said door panel and a middle point spaced between said first end and said second end, the part of said link between said first end and said middle point being smoothly arched, the actuator of each said driving mechanism comprises a casing having a fixed end pivotally connected to one wall panel of said construction adjacent to one said access hole and a free end opposite to said fixed end, and a reciprocating rod coupled to said casing and movable in and out of said free end of said casing, said reciprocating rod having one end thereof slidably coupled to said casing and an opposite end thereof pivotally connected to the middle point of the link of the respective driving mechanism.

9. An indoor open type door panel mounting structure, comprising:
a construction having at least one access hole defined in one of a plurality of wall panels thereof;
at least one door panel respectively hinged to said construction and adapted for closing said at least one access hole, each said door panel comprising two panel members hinged to one wall panel of said construction at one side of one said access hole and arranged in a parallel manner; and
at least one driving mechanism each comprising an actuator an actuator, said actuator comprising a casing connected to one wall panel of said construction and a reciprocating rod movable in and out of said casing, two links each having a first end respectively pivotally coupled to the free end of said reciprocating rod and a second end opposite to said first end, two push rods respectively pivotally coupled between the second ends of said inks and a respective inner surface of each of the two panel members of one said door panel, and two connection rods respectively pivotally coupled between one wall panel of said construction and a middle part of each of said links.
